(19) United States
(12) Patent Application Publication
(10) Pub. No.: US 2010/0256878 A1
(43) Pub. Date: Oct. 7, 2010

(54) ROAD FINISHER

(75) Inventor: Guenter Zegowitz, Bad Koenig (DE)

Correspondence Address: FISH & RICHARDSON P.C., P.O. BOX 1022, MINNEAPOLIS, MN, 55440-1022, US

(73) Assignee: JOSEPH VOEGELE AG, Mannheim (DE)

(21) Appl. No.: 12/720,794

(22) Filed: Mar. 10, 2010

(30) Foreign Application Priority Data
Apr. 3, 2009 (EP) 09005011.3

(51) Int. Cl. G06F 7/00; E01C 19/00; H04Q 5/22

(52) U.S. Cl. 701/50; 340/10.1

(57) ABSTRACT

The invention relates to a road finisher (F) comprising a tractor (1), a programmed or programmable control unit (C), and one or a plurality of mechanical auxiliary components (Z) which are adapted to be selectively attached to the tractor (1). The invention is characterized in that the at least one mechanical auxiliary component (Z) is provided with a wireless-readable identification means (21), that the tractor (1) is provided with a read head (20) suitable for reading the identification means (21), and that the identification of the auxiliary component (Z) read by the read head (20) is adapted to be supplied to the control unit (C).

The present invention relates to a road finisher comprising a programmed or programmable control unit, and one or a plurality of auxiliary components which are adapted to be selectively attached to the road finisher.

In practice, road finishers are known, which are provided with a tractor having attached thereto a compacting device, the so-called screed. These screeds are available as an extending screed, a rigid screed or a special screed. The screed is therefore regarded as a mechanical, exchangeable auxiliary component.

The material, e.g. a pavement mix, for the pavement to be produced is transported by means of the tractor and, while the tractor is travelling, the material is distributed across the desired road width. The screed is used for compressing and smoothing the pavement.

These known road finishers can be upgraded by various mechanical auxiliary components so as to allow an extremely great variety of applications. For example, different screeds may be used, or fixed extensions may be laterally attached to the screed so as to increase the laying width. In the case of some road finishers it is also possible to connect auxiliary components to the tractor so as to upgrade the road finisher to a spray paver. In a spray paving process, a binder, e.g. a bitumen emulsion, is applied to the raw base, i.e. the “plane”, so as to form there an adhesion layer for the pavement applied immediately afterwards. For upgrading the road finisher to a spray paver, the road finisher has attached thereto as auxiliary modules e.g. one or a plurality of spray modules for storing, heating, filtering and discharging the bitumen emulsion, lateral spray bars and/or auxiliary tank modules.

The conventional road finisher is additionally provided with a control unit which is programmable in different ways and which controls and supervises all the sequences of operations and components on the road finisher.

In order to enable the control unit to fulfil these functions, the operating personnel must configure or program the control unit in a suitable manner after each retooling/changeover of the road finisher. This necessitates especially an input of the data of all auxiliary devices, normally through a keyboard, so that the control unit will be able to take into account these auxiliary components.

It is obvious that these manual programming of the control unit is unsatisfactory. On the one hand, the programming causes longer down times of the road finisher, since the finisher cannot continue its work until said programming has been finished. On the other hand, if wrong data should be inputted inadvertently, this may result in incorrect programming and interfere with the road laying process.

It is the object of the present invention to provide a road finisher in the case of which these problems are overcome by means having the simplest possible structural design, without impairing in the least the wide variety of uses of the road finisher.

This object is achieved by a road finisher having the features of claim 1. Advantageous further developments of the invention are specified in the subclaims.

The present invention is so conceived that the at least one mechanical auxiliary component, which can be attached to the road finisher, is provided with a wireless-readable identification means that can be read by means of a suitable read head on the road finisher, whereupon the identification of the auxiliary component read by the read head can be supplied to the control unit for configuring there the control program of the road finisher in dependence upon the identified auxiliary component or auxiliary components. These features provide a plurality of advantages. The essential aspect of the present invention is to be seen in that the mechanical auxiliary components, which can be provided selectively and part of which are interchangeable, will be recognized automatically on the road finisher and will then be taken into account in the control program of the road finisher. A time-consuming and possibly interference-prone manual programming can be dispensed with. In view of the fact that the read head is configured for wireless reading of the identification means, it is not necessary to connect the auxiliary components to the road finisher through electric cables, which would again take much time, unless this should be necessary for operating the auxiliary components in some other respect.

Suitable mechanical auxiliary components for the road finisher, for which the identification according to the present invention will be advantageous, are e.g. a screed, screed extensions, a spray module, an auxiliary tank module, spray bars, and/or other mechanical devices.

According to a preferred embodiment, the identification means includes a memory, at least part of which can be written on, and the read head on the tractor is implemented simultaneously as a write/read head for reading the memory of the identification means and for writing into the same. This allows a more versatile use of the identification means. They do not only serve to output an identification, such as a barcode, but they are also able to store data that vary with time and that concern the operation of the respective auxiliary component.

It is, for example, imaginable that the identification means contains data for identifying the module number, the type, the model, the dimensions, the operating data and/or the maintenance data of the respective auxiliary component. The module number may be an individual serial number of the auxiliary component. The type of the auxiliary component indicates its intended use, e.g. whether the auxiliary component in question is a screed extension, an auxiliary tank or a spray module. The models and the dimensions comprise special characteristics of the respective auxiliary component, viz. in the case of a tank e.g. its holding capacity, in the case of a spray module the pressure that can be generated, in the case of a screed extension the dimensions of said extension and the compacting units provided therefor. The operating data specify the former sequence of operations of the respective auxiliary component, e.g. the added-up number of operating hours. The maintenance data can indicate when the auxiliary component was serviced last, or after which period of time the next servicing should take place.

According to a particularly advantageous embodiment of the present invention, the identification means is an RFID (radio frequency identification) transponder. Accordingly, the read head, or the write/read head will then be an RFID (write/)read head.

In the case of the RFID technique, which has primarily been used in the logistics branch up to now, communication between a write/read head and a “TAG” or transponder takes place via radio waves which may have a frequency between a few kilohertz up to several hundred gigahertz. The radio signal emitted by the write/read head has two functions. On the one hand, it serves to effect inductive energy transmission to the transponder. On the other hand, it serves to excite an oscillating circuit on the transponder so as to effect wireless reading of the signals which are stored on the transponder and which identify the transponder.

In the present case of a road finisher, the RFID technique has the immense advantage that it will work failure-free even under the most adverse ambient conditions. Neither the high temperatures required for roadmaking nor the dirt that cannot be avoided when roads are being constructed will impair the efficiency of RFID communication nor will said efficiency be impaired by dust or moisture. Even if there is no optical line-of-sight connection between the transponder or data carrier and the read head or read station, an exchange of data will always take place reliably in one or both directions. It goes without saying, that other communication systems may be used as well.

According to an expedient embodiment, the road finisher has provided thereon a communication bus for communication between the control unit and the read head or the write/read head. Making use of this communication bus, various read heads which serve to identify various auxiliary components can be accessed.

According to a preferred embodiment, an evaluation unit is provided in the control unit or between the read head and the control unit, said evaluation unit being used for evaluating the identification of the auxiliary component read by means of the read head. The evaluation unit serves to convert the signals received at the read head into a format suitable for the control unit.

The tractor may have provided thereon a plurality of read heads or write/read heads. It will be of advantage when a respective read head is directed towards the place of installation of an auxiliary component so that this auxiliary component can be recognized more easily.

According to a preferred embodiment, the road finisher is provided with indicating means for indicating to an operator of the road finisher the identified auxiliary component or auxiliary components. If necessary, the operator of the road finisher will thus be able to check whether all the relevant auxiliary components have been correctly detected.

In order to improve these functions still further, the indicating means may be suitable for indicating the ascertained module number, the type, the model, the dimensions, the operating data and/or the maintenance data of a specific auxiliary component. What would be imaginable is a menu navigation of the indication, by means of which the operator can retrieve the respective information.

According to an advantageous variant, the operating data of a specific auxiliary component can be updated on the identification means of said auxiliary component with due regard to the auxiliary component operating time which is determined by means of the control unit. To this end, the control unit may automatically measure the time for which a specific auxiliary component was in operation. When a specific control program is terminated or when the road finisher is switched off, the updated operating time will be stored on the identification means of the auxiliary component.

According to the present invention, the road finisher may additionally have provided thereon a sensor for measuring a length characterizing the current position or dimensions of a component. The component can be one of the replaceable auxiliary components or a component that is movably arranged on the road finisher. The measured length can then be taken into account automatically in the control unit in the program used for controlling the road finisher.

It would, for example, be imaginable that the sensor is configured to measure the length by means of a transit time measurement of an optical or electromagnetic signal. In view of the influence that dust, fog or dirt may have, an electromagnetic signal is preferred to an optical one. For the transit time measurement, a time measurement element, e.g. a counter, may be provided on the sensor so as to measure the time between the transmission and the reception of a signal.

In particular, it would be imaginable that the measured length is a distance between the read head and the identification means of an auxiliary component, and that the read head, which is configured for reading the identification means, is simultaneously implemented as a sensor for measuring this distance by means of a transit time measurement. If the identification means in question is an RFID transponder, the radio waves emitted by the read head may e.g. be used for reading the identification means as well as for determining, through a measurement of their transit time, the distance to the auxiliary component.

In the following, an advantageous embodiment of the present invention will be explained in more detail on the basis of a drawing. In detail,

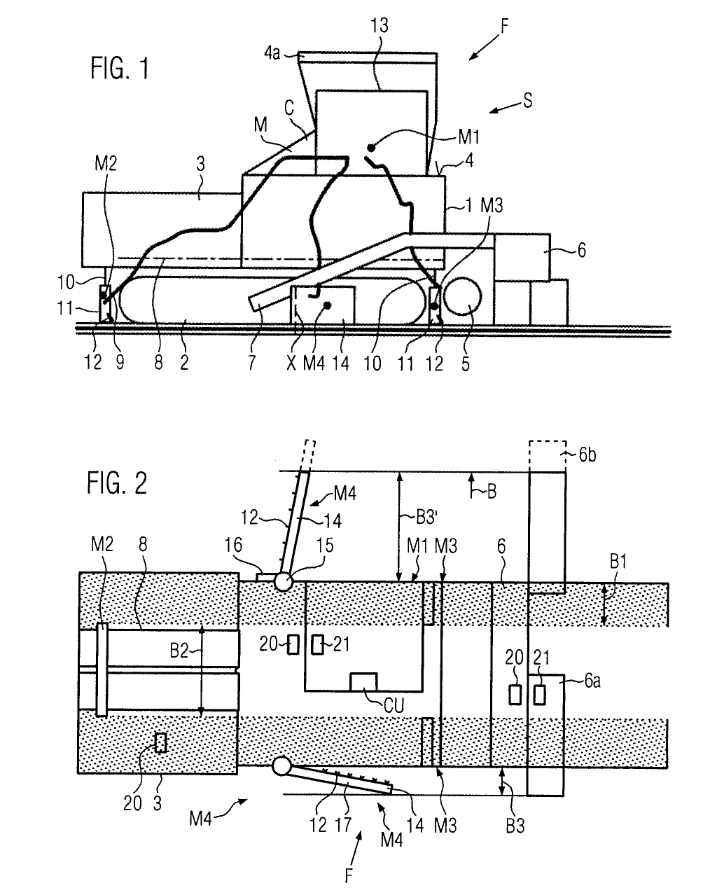

FIG. 1 shows a schematic side view of a road finisher,

FIG. 2 shows a schematic top view of the road finisher shown in FIG. 1,

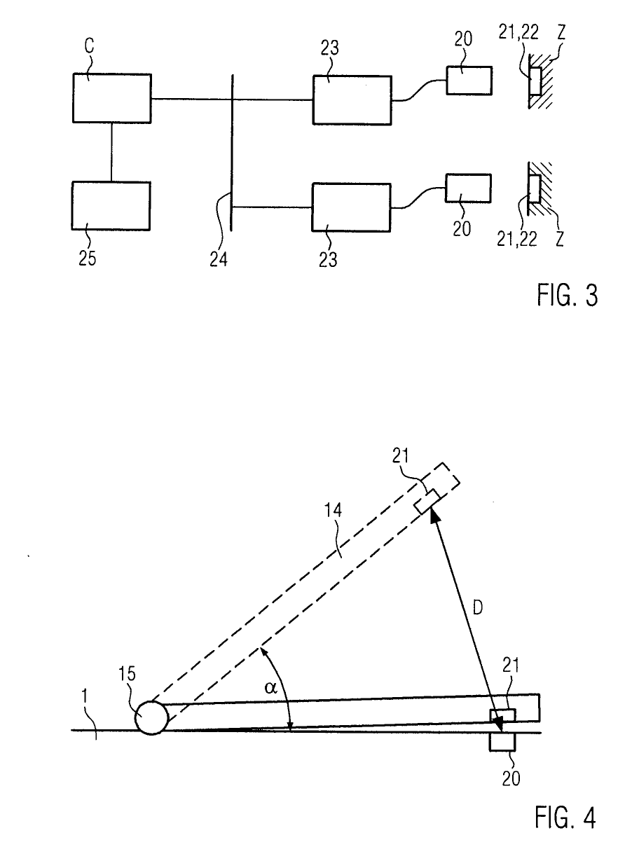

FIG. 3 shows a schematic representation of the identification system on the road finisher, and

FIG. 4 shows a schematic representation of the distance measurement on a pivotable spray bar.

Identical components are identified by identical reference numerals in all the drawings.

FIG. 1 shows, in a schematic side view, a road finisher F with a tractor 1. The tractor 1 is driveable by means of a motorized running gear 2, which may e.g. be a tracked running gear or a wheel-type running gear. In the front area of the tractor 1, a material bunker 3 is provided for accommodating the material for the pavement to be applied, said material being especially a pavement mix. The driver's cab of the tractor 1 is arranged on an operating platform 4, said driver's cab being protected by a roof 4a, which can preferably be removed or pivoted away.

The tractor end representing the rear end when seen in the direction of movement has provided thereon a lateral distributor device 5, e.g. an auger, which distributes the pavement mix to be discharged over the whole laying width. The lateral distributor device 5 is followed by a screed 6 provided with means for compressing and smoothing the discharged material, e.g. via tampers, pressure bars and screed plates; these means are not shown. The screed 6 is articulated on the tractor through an upwardly pivotable bar 7 and is towed by the tractor.

A horizontal conveyor 8, e.g. a scraper belt or a plurality of juxtaposed scraper belts, is provided below the material bunker 3 and the operating platform 4. The conveyor 8 is used for conveying the pavement mix out of the material bunker 3, passing it below the operating platform 4 and conveying it to the lateral distributor device 5.

From the top view in FIG. 2, it can be seen that the screed 6, which is here implemented as an extending screed, comprises two extensions 6a that are laterally extendible so as to increase the operating width of the road finisher F. It would also be imaginable to attach additional, fixed extensions 6b to the primary screed 6 or to its extensions 6a, as further auxiliary components.

The tractor 1 has provided thereon a programmable control unit C which controls and coordinates the operation of the primary drive M of the tractor, the screed 6, the conveyor 8, the lateral distributor device 5 and e.g. the spray unit S.

In the case of a conventional road finisher with auxiliary components the operator had to input the parameters of all the auxiliary components into the control unit C by hand so that they could be taken into account in the control program executed there, whereas in the case of the present invention all the auxiliary components can be recognized and taken into account automatically. For this purpose, a plurality of write/read heads 20 is distributed over the tractor 1, as can be seen from FIGS. 2 and 3, said write/read heads 20 being adapted to emit radio waves in the range of a few kilohertz up to several hundred gigahertz. The write/read heads 20 are therefore especially part of an RFID system with suitable complements in the form of RFID transponders or identification means 21 arranged on the respective auxiliary components Z, e.g. on one of the screed extensions 6a, 6b. The identification means 21 are provided with a memory 22, part of which can be written on. The write/read heads 20 are configured to transmit energy to the identification means 21 through the radio waves and to read the memory 22 of the identification means 21 as well as write into said memory 22. The data stored in the memory 22 can comprise data identifying the module number, the type, the model, the dimensions, the operating data and/or the maintenance data of the respective auxiliary component Z. It would be imaginable to store the data concerning the module number, the type, the model and the dimensions in the memory part that cannot be written on, whereas the operating data and the maintenance data of the respective auxiliary component Z can be stored in the memory part that can be written on. Each write/read head 20 has associated therewith an evaluation unit 23 used for converting the signal transmitted by the identification means 21 and received at the write/read head 20 into a format that can be read by the control unit C. The evaluation unit 23 may e.g. be an analog to digital converter. Alternatively to the provision of a separate evaluation unit 23 for each write/read head 20, it would be imaginable to provide a common evaluation unit 23 on or in the control unit C.

Communication between the write/read heads and the control unit C of the road finisher F takes place via a communication bus 24. Via said communication bus 24 the data read are transmitted from the write/read head 20 or from the respective evaluation unit 23 to the central control unit C. It would be imaginable that the write/read heads 20 are also supplied with control signals and/or with current via the bus 24.

The control unit C is configured to store the identification means data received from the write/read heads 20 and, in particular, to modify the control program for the road finisher F in dependence upon the identified auxiliary devices Z and their properties. In addition, an indicating means 25, e.g. a display, is provided. The auxiliary devices Z of the road finisher F recorded by the control unit C are displayed by the indicating means 25. Specific properties of these auxiliary devices Z can be selected and displayed via a menu.

In FIG. 2 it can be seen that the write/read heads 20 are arranged on the tractor in such a way that they are suitably oriented for recognizing the identification means 21 of a specific auxiliary component Z, especially they are arranged in the vicinity of the identification means 21, when the auxiliary component Z is provided on the road finisher F. One write/read head 20 is, for example, arranged on the tractor such that it is located close to the RFID identification means 21 of the screed 6. Another write/read head 20 is arranged e.g. on the screed 6 such that it is located as close as possible to the identification means 21 on an extension 6a of the screed. Another write/read head 20 can be provided on the material bunker 3 so as to identify there an auxiliary tank (which is not shown in FIG. 2) of a spray unit S or a material bunker insert as an additional, optional auxiliary component Z.

In the case of some components, especially in the case of the extending screeds 6a, the position or the orientation of the respective component relative to the tractor 1 can be varied. This position, in addition to the invariable dimensions of the respective auxiliary component, can represent another important magnitude in the control of the road finisher F. An advantageous embodiment of the present invention is therefore provided with a sensor for automatically measuring the position of the respective auxiliary component Z and for supplying it to the control unit C. The position of the auxiliary component Z can especially be determined through a length measurement.

In the embodiment shown in FIG. 4, the auxiliary component Z is a spray bar 14. The tractor 1 of the road finisher F has provided thereon a write/read head 20 which is suitably oriented for communicating with an identification means 21 on the spray bar 14. At a first position, indicated by solid lines, the spray bar 14 abuts on the tractor 1 parallel to the direction of movement of the road finisher F. The distance between the write/read head 20 and the identification means 21 is extremely small. At a second position, indicated by broken lines, the spray bar 14 extends at an angle relative to the tractor 1. The distance D between the write/read head 20 and the identification means 21 represents a measure for the angle α at which the spray bar 14 extends.

The measurement of the distance D can be executed especially by means of a transit time measurement of an electromagnetic signal. The signal used for this purpose is preferably the signal of the radio waves used for reading the RFID identification means 21. As soon as the write/read head 20 emits the radio waves, a counter or a counting device starts running in the write/read head 20. The write/read head 20 records the reception of the signal sent back by the identification means 21 and stops the counting device as soon as the signal has been received. The longer the time that elapses between the transmission and the reception of the signal, the larger the angle at which the spray bar 14 extends relative to the tractor 1 is. The measured time, which corresponds to the distance D, i.e. the angle α, can be supplied to the control unit C so that the position of the spray bar 14 will there be taken into account automatically. The larger the angle between the spray bar 14 and the road finisher F is, the more bitumen emulsion per unit time will have to be distributed by the spray bar 14 so as to create a pavement of constant thickness on the plane. The discharged amount of bitumen emulsion may be accomplished by the pressure in the spray unit S and/or by controlling valve elements 17 in the spray bar 14.

In the case of one embodiment it may also make sense to execute a position determination, especially through a length measurement, with respect to the position of the screed extensions 6a, 6b. This length measurement may be executed at right angles to the direction of movement of the road finisher F, i.e. parallel to the length of the screed 6. In so doing, the distance between a write/read head 20 on the fixed screed 6 and a reflector on the end of the extensions 6a, 6b may be determined. The reflector may be an identification means 21 or an element acting exclusively as a reflector.

Taking as a basis the embodiment shown, the road finisher F according to the present invention may be modified in many ways. Instead of the RFID technique also other wireless communication methods may be used for automatically recognizing auxiliary components Z. As can be seen in FIG. 2, a write/read head 20 could be provided on the material bunker 3 so as to recognize and identify an auxiliary tank provided there for the spray unit S or a material bunker insert as an additional auxiliary component Z.

According to a simpler variant of the present invention, the identification means 21 may have a non-rewritable memory 22. In this case it would suffice to use mere read heads 20 instead of the write/read heads 20.

The identification means, in particular the RFID transponders, may also be used in stock-keeping for recording the auxiliary components which are not used and therefore kept in stock at the time in question.

1. A road finisher comprising a tractor, a programmed or programmable control unit, and one or a plurality of mechanical auxiliary components which are adapted to be selectively attached to the tractor,
wherein the at least one mechanical auxiliary component is provided with a wireless-readable identification means, that the tractor is provided with a read head suitable for reading the identification means, and that the identification of the auxiliary component read by the read head is adapted to be supplied to the control unit.

2. A road finisher according to claim 1, wherein the auxiliary components comprise a screed, a screed extension, spray modules, an auxiliary tank module, one or a plurality of spray bars, conveyor belts and/or other mechanical devices.

3. A road finisher according to claim 1, wherein the identification means includes a memory, at least part of which can be written on, and that the read head on the tractor is implemented as a write/read head for reading the identification means and for writing into the same.

4. A road finisher according to claim 1, wherein the identification means contains data for identifying the module number, the type, the model, the dimensions, the operating data and/or the maintenance data of the respective auxiliary component.

5. A road finisher according to claim 1, wherein the identification means is an RFID (radio frequency identification) transponder.

6. A road finisher according to claim 5, wherein a communication bus is provided for communication between the control unit and the read head or the write/read head.

7. A road finisher according to claim 1, wherein an evaluation unit is provided in the control unit or between the read head and the control unit, said evaluation unit being used for evaluating the identification of the auxiliary component read by means of the read head.

8. A road finisher according to claim 1, wherein the tractor has provided thereon a plurality of read heads or write/read heads, which are each directed towards the place of installation of a respective auxiliary component.

9. A road finisher according to claim 1, wherein an indicating means is provided for indicating to an operator of the road finisher the identified auxiliary component or auxiliary components.

10. A road finisher according to claim 9, wherein the indicating means is suitable for indicating the ascertained module number, the type, the model, the dimensions, the operating data and/or the maintenance data of an auxiliary component.

11. A road finisher according to claim 1, wherein the operating data of an auxiliary component can be updated on the identification means of said auxiliary component.

12. A road finisher according to claim 1, wherein a sensor is provided for measuring a length (D) characterizing the current position or dimensions of a component so as to configure, in dependence upon the measured length, in the control unit the program used for controlling the road finisher.

13. A road finisher according to claim 12, wherein the sensor is configured to measure the length (D) by means of a transit time measurement of an optical or electromagnetic signal.

14. A road finisher according to claim 12, wherein the length (D) is a distance between the read head and the identification means, and that the read head is implemented as a sensor for measuring this distance by means of a transit time measurement of an optical or electromagnetic signal.

15. A road finisher according to claim 13, wherein the length is a distance between the read head and the identification means, and that the read head is implemented as a sensor for measuring this distance by means of a transit time measurement of an optical or electromagnetic signal.
